(19) United States
(12) Patent Application Publication
(10) Pub. No.: US 2025/0097107 A1
(43) Pub. Date: Mar. 20, 2025

(54) INFORMATION PROCESSING SYSTEM. NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Akihide OSHIMA, Kanagawa (JP)

(73) Assignee: FUJIFILM Business Innovation Corp., Tokyo (JP)

(21) Appl. No.: 18/437,689

(22) Filed: Feb. 9, 2024

(30) Foreign Application Priority Data
Sep. 20, 2023 (JP) 2023-153895

(51) Int. Cl. H04L 41/084; H04L 41/0823

(52) U.S. Cl. CPC H04L 41/0846; H04L 41/0823

(57) ABSTRACT

An information processing system includes a processor configured to: execute a process affecting work of a user at a timing at which the process does not affect the work of the user, in a synchronization process of synchronizing data stored in an external device with data in the information processing system.

### CROSS-REFERENCE TO RELATED APPLICATIONS

This application is based on and claims priority under 35 USC 119 from Japanese Patent Application No. 2023-153895 filed Sep. 20, 2023.

### BACKGROUND

### (i) Technical Field

The present disclosure relates to an information processing system, a non-transitory computer readable medium storing a program, and an information processing method.

### (ii) Related Art

JP6574558B discloses an information processing apparatus capable of completing a setting reflection process while suppressing an unnecessary restart process, by switching a reflection process in response to a change request of setting data in accordance with an optional configuration or capability.

### SUMMARY

There is known an information processing system that periodically executes a synchronization process of synchronizing data stored in an external device with data of an own system or executes the synchronization process based on an instruction of an administrator user or the like to reflect information of the settings of the information processing system, the usage status of the information processing system, and the like to data that is transmitted from the information processing system to the external device and then is stored in the external device, or to reflect setting contents of data stored in the external device to the information processing system.

Since the synchronization process includes a process of changing the settings necessary for the operation of this system, the process that can be executed in this system is restricted during the execution of the synchronization process. Therefore, there is a problem that, during the execution of the synchronization process, it is necessary to restrict the operation of the user in this system, which affects the work of the user.

Aspects of non-limiting embodiments of the present disclosure relate to an information processing system, a non-transitory computer readable medium storing a program, and an information processing method that are capable of executing a synchronization process without affecting work of a user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: execute a process affecting work of a user at a timing at which the process does not affect the work of the user, in a synchronization process of synchronizing data stored in an external device with data in the information processing system.

### BRIEF DESCRIPTION OF THE DRAWINGS

Exemplary embodiment(s) of the present invention will be described in detail based on the following figures, wherein:

FIG. 1 is a diagram showing a configuration of a digital shadow system according to an exemplary embodiment of the present disclosure;

FIG. 2 is a diagram for describing a synchronization process executed between a cloud server and an image forming apparatus;

FIG. 3 is a block diagram showing a hardware configuration of the image forming apparatus in the exemplary embodiment;

FIG. 4 is a block diagram showing a functional configuration of the image forming apparatus in the exemplary embodiment; and

FIG. 5 is a diagram showing a relationship between a type of the synchronization process and a prohibition period.

### DETAILED DESCRIPTION

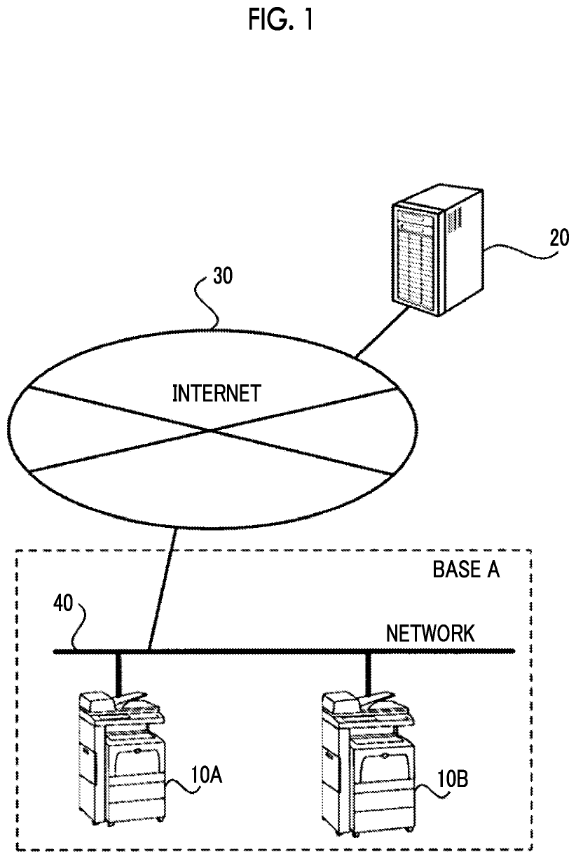

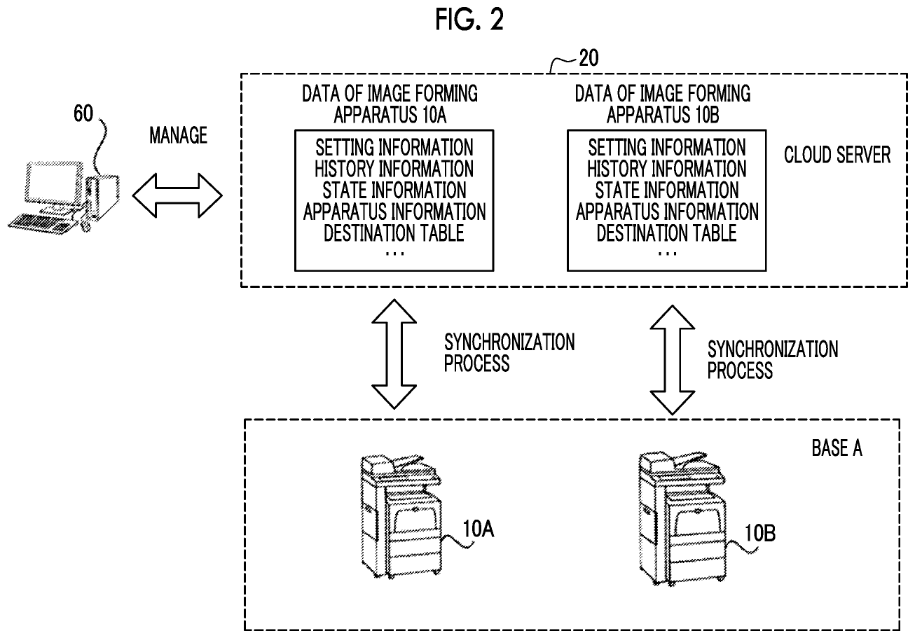

Hereinafter, an exemplary embodiment of the present disclosure will be described in detail with reference to the drawings. FIG. 1 is a diagram showing a configuration of a digital shadow system according to the exemplary embodiment of the present disclosure. FIG. 2 is a diagram for describing a synchronization process executed between a cloud server 20, and image forming apparatuses 10A and 10B.

As shown in FIG. 1, the digital shadow system in the exemplary embodiment of the present disclosure has a configuration in which two image forming apparatuses 10A and 10B installed in a base A and the cloud server 20 are connected to each other via the Internet 30. The image forming apparatuses 10A and 10B are mutually connected by a network 40 in the base A. The image forming apparatuses 10A and 10B are so-called multifunction devices having a plurality of functions such as a printing function, a scanning function, a copying function, and a facsimile function. The image forming apparatuses 10A and 10B are examples of an information processing system in the technique of the present disclosure. The cloud server 20 is an example of an external device in the technique of the present disclosure.

As shown in FIG. 2, the cloud server 20 provides a service called digital shadow in which various types of data such as setting information, history information, state information, apparatus information, and a destination table, which are stored in a physical device connected by the Internet 30 are stored in synchronization with the physical device.

Specifically, the cloud server 20 stores various types of data such as the setting information, the history information, the state information, the apparatus information, and the destination table of the image forming apparatuses 10A and 10B that are physical devices while executing the synchronization process with the image forming apparatuses 10A and 10B.

Here, the setting information is information related to the setting necessary for the operations of the image forming apparatus 10A and 10B.

The history information is information related to the history of jobs such as printing, scanning, copying, and facsimile, which are executed by the image forming apparatus 10A and 10B. Examples of the history information include information related to the execution time of a job, the number of times of executing the job, and the billing amount when the job is executed, and the like.

The state information is information related to a state that changes with the lapse of time in the image forming apparatus 10A and 10B. Examples of the state information include information related to the remaining amount of consumables such as a toner and paper in the image forming apparatus 10A and 10B, an operation status (during a normal operation or during the stop due to an occurrence of an abnormality) of the image forming apparatus 10A and 10B, and the like.

The apparatus information is information related to the device configuration of the image forming apparatuses 10A and 10B, that is, the functions mounted on the image forming apparatuses 10A and 10B.

The destination table is information such as a name, a facsimile number, and an e-mail address, which is managed for each destination.

With such a service, even in a case where it is not possible that a terminal device that manages a certain device is directly connected to a management target device, the terminal device can check the state of the management target device and perform the management such as setting change. For example, a case where an external terminal device 60 attempts to change the setting information of the image forming apparatus 10A will be described. First, the external terminal device 60 changes the setting information of the image forming apparatus 10A in the cloud server 20. Then, in a case where the image forming apparatus 10A executes the synchronization process with the cloud server 20, the image forming apparatus 10A acquires the updated setting information and changes the setting information of the image forming apparatus 10A.

That is, by using such a service, even in a case where connection of the external terminal device 60 to the image forming apparatuses 10A and 10B set in the base A is not possible, the external terminal device 60 can check the states of the image forming apparatuses 10A and 10B, update the setting information, and the like.

Next, the image forming apparatus 10A in the digital shadow system of the present exemplary embodiment will be described in detail. In the following description, the description will be made focusing on the operation of the image forming apparatus 10A, and the image forming apparatus 10B and the like also have the similar configuration.

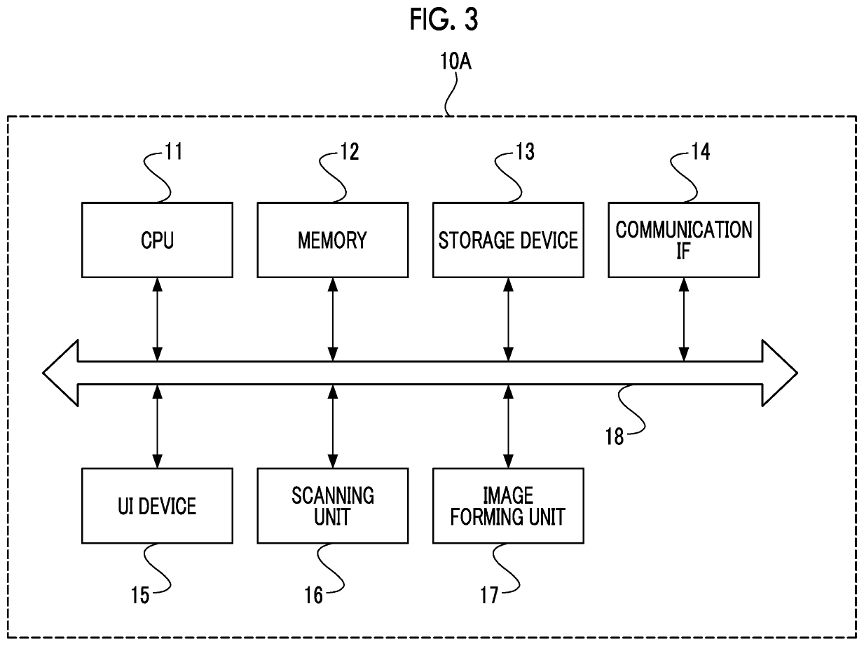

FIG. 3 is a block diagram showing a hardware configuration of the image forming apparatus 10A in the present exemplary embodiment. As shown in FIG. 3, the image forming apparatus 10A includes a central processing unit (CPU) 11, a memory 12, a storage device 13 such as a hard disk drive, a communication interface (abbreviated as an IF) 14 for transmitting and receiving data to and from an external device and the like via the network, a user interface (abbreviated as an UI) device 15 including a touch panel, a liquid crystal display, and a keyboard, a scanning unit 16, and an image forming unit 17. These components are connected to each other via a control bus 18.

The CPU 11 is a processor that controls the operation of the image forming apparatus 10A by executing a predetermined process based on a control program stored in the memory 12 or the storage device 13. In the present exemplary embodiment, description will be made on the assumption that the CPU 11 reads and executes the control program stored in the memory 12 or the storage device 13, but the present disclosure is not limited to this. The control program may be provided in a form of being recorded on a computer readable recording medium. For example, the program may be provided in a form of being recorded on an optical disk such as a compact disc (CD)-ROM and a digital versatile disc (DVD)-ROM, or in a form of being recorded on a semiconductor memory such as a universal serial bus (USB) memory and a memory card. Further, the control program may be acquired from the external device via a communication line connected to the communication IF 14.

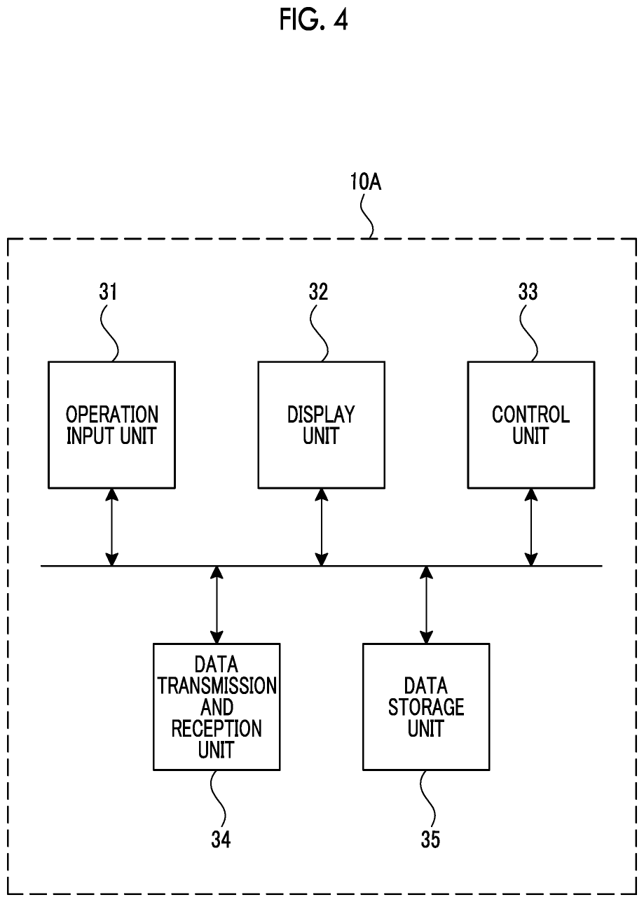

FIG. 4 is a block diagram showing a functional configuration of the image forming apparatus 10A implemented by executing the control program. As shown in FIG. 4, the image forming apparatus 10A in the present exemplary embodiment includes an operation input unit 31, a display unit 32, a control unit 33, a data transmission and reception unit 34, and a data storage unit 35. In the block diagram shown in FIG. 4, functional blocks related to image formation processing and the like are omitted.

The operation input unit 31 inputs information on various operations performed by the user. The display unit 32 is controlled by the control unit 33 and displays various types of information to the user.

The control unit 33 performs control processing for the overall operation of the image forming apparatus 10A. In addition, the control unit 33 stores shared data acquired from the cloud server 20 via the data transmission and reception unit 34 in the data storage unit 35, and, for example, periodically communicates with the cloud server 20, and executes a synchronization process of synchronizing the shared data in the data storage unit 35 with the shared data stored in the cloud server 20.

The data transmission and reception unit 34 transmits and receives data to and from an external device such as the cloud server 20. The data storage unit 35 stores various types of data such as the destination table synchronized with the cloud server 20.

Examples of the synchronization process executed in the digital shadow system include a plurality of types of synchronization process such as a periodic synchronization process in which the synchronization process is periodically executed, and an immediate synchronization process instructed to be immediately executed by the user.

In any case, since the synchronization process may include a process of changing the setting necessary for the operation of the image forming apparatus 10A, basically, the process that can be executed in the image forming apparatus 10A is restricted during the execution of the synchronization process.

Specifically, for example, the execution of processes such as printing, scanning, copying, and facsimile (referred to as jobs below) is restricted, and the operation input for instructing the execution of the jobs is also restricted. Further, even in a case where there is a job requested by the user, in a case where a synchronization process executed at a predetermined time, for example, the periodic synchronization process is generated, the job requested by the user may be postponed.

As described above, during the execution of the synchronization process, the process may affect work of the user, for example, the operation input of the user may be restricted, the job requested by the user may be postponed, or the like.

In order to address such a problem, the control unit 33 in the present exemplary embodiment executes a process that affects work of the user at a timing at which the process does not affect the work of the user, in the synchronization process of synchronizing data stored in the cloud server 20 with data in the image forming apparatus 10A.

Specifically, the control unit 33 may execute the synchronization process in a time range set in advance. Here, the time range may be any timing as long as the process does not affect the work of the user. For example, a lunch break time in a company (for example, time between 12:00 and 13:00), a nighttime (for example, time between 0:00 and 5:00), and the like may be set as the time range. The control unit 33 may set the time range based on an instruction of the user.

The control unit 33 may execute the synchronization process that is exceptionally instructed to be executed, or the immediate synchronization process, regardless of the time range set in advance.

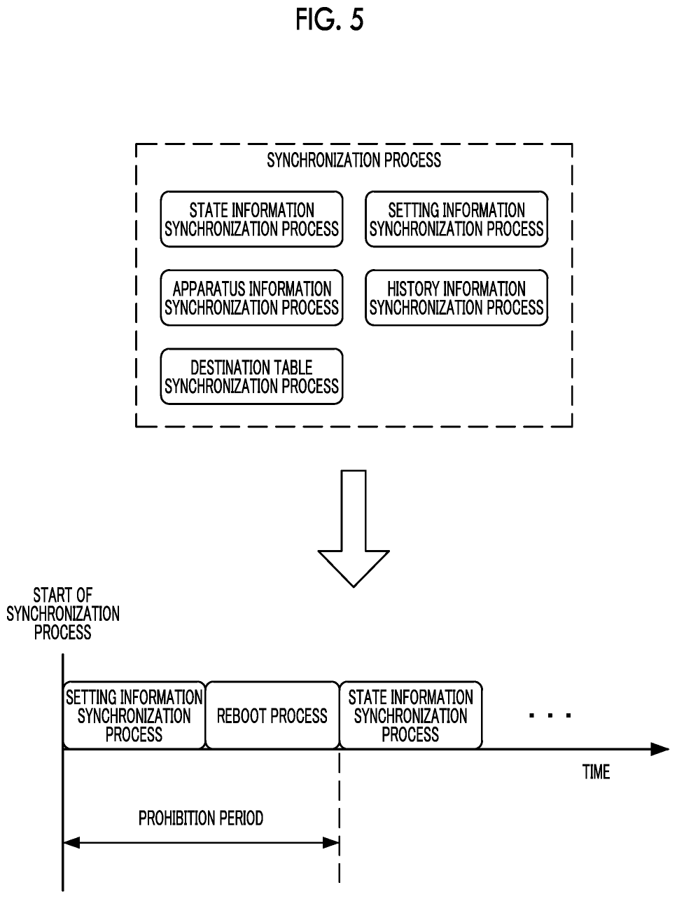

In addition, as shown in FIG. 5, in a case where the synchronization process includes a synchronization process of setting information that is information related to settings necessary for the operation of the image forming apparatus 10A, the control unit 33 may continuously execute the synchronization process of setting information and a reboot process (restart process) associated with this synchronization process, and set a period in which the synchronization process of setting information and the reboot process associated with this synchronization process are executed, as a prohibition period in which the operation input from the user is prohibited.

Here, in the example of FIG. 5, the synchronization process of the setting information and the reboot process associated with the synchronization process are executed at the beginning of the synchronization process, but the present disclosure is not limited to such an aspect. The synchronization process of the setting information and the reboot process associated with the synchronization process may be executed in the middle or at the end of the synchronization process. Further, the execution order of the synchronization process other than the synchronization process of the setting information is not particularly limited and can be appropriately set.

In a case where the reboot process associated with the synchronization process of the setting information is unnecessary, the reboot process may be omitted. In a case where it is not necessary to execute the reboot process associated with the synchronization process of the setting information immediately after the synchronization process of the setting information, the reboot process may be executed after the other process.

The control unit 33 may receive the operation input of the content other than the content related to an instruction to execute a job even during the prohibition period. Here, the operation input of the content other than the content related to the instruction to execute the job means an operation that is not affected by the synchronization process that is being executed, for example, an operation of checking the execution history of the job in the image forming apparatus 10A, an operation of changing information that does not require immediacy of synchronization, or the like.

The control unit 33 may receive the operation input from the user even during the synchronization process, and, in a case where it is not possible that a job of the content subjected to the operation input is executed in parallel with the synchronization process, the control unit 33 may stop the synchronization process that is being executed and execute the job of the content subjected to the operation input.

According to such an aspect, in a case where the synchronization process including the setting update of the image forming apparatus 10A is executed, the old setting is stored in another recording area in the data storage unit 35 until the synchronization process is completely ended. In a case where the synchronization process including the setting update of the image forming apparatus 10A is stopped in the middle, the job of the content subjected to the operation input from the user may be executed by not using the setting in the middle of being updated, but using the old setting stored in the data storage unit 35.

The control unit 33 may execute the stopped synchronization process after the execution of the job of the content subjected to the operation input is ended.

### Modification Examples

Although the information processing system according to the exemplary embodiment of the present disclosure has been described above, the present disclosure is not limited to the above-described exemplary embodiment and can also be appropriately changed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the term “system” in the present exemplary embodiment includes both a system configured by a plurality of devices and a system configured by a single device.

### Supplementary Notes

Hereinafter, supplementary notes of the aspects of the present disclosure will be described.

### 1

An information processing system comprising:
a processor configured to:
   execute a process affecting work of a user at a timing at which the process does not affect the work of the user, in a synchronization process of synchronizing data stored in an external device with data in the information processing system.

### 2

The information processing system according to (((1))), wherein the processor is configured to:
execute the synchronization process in a time range set in advance.

### 3

The information processing system according to (((2))), wherein the processor is configured to:
set the time range based on an instruction of the user.

### 4

The information processing system according to (((2))) or (((3))), wherein the processor is configured to:
execute the synchronization process that is exceptionally instructed to be executed, regardless of the time range set in advance.

### 5

The information processing system according to (((2))) or (((3))), wherein the processor is configured to:
execute the synchronization process that is instructed to be immediately executed, regardless of the time range set in advance.

### 6

The information processing system according to any one of (((1))) to (((5))), wherein the processor is configured to:
in a case where the synchronization process of setting information that is information related to setting necessary for an operation of the information processing system is included in the synchronization process,
continuously execute the synchronization process of the setting information and a restart process associated with the synchronization process of the setting information; and
set a period in which the synchronization process of the setting information and the restart process associated with the synchronization process of the setting information are executed, as a prohibition period in which an operation input from the user is prohibited.

### 7

The information processing system according to (((6))), wherein the processor is configured to:
receive an operation input having contents other than contents related to an instruction to execute the process even in the prohibition period.

### 8

The information processing system according to any one of (((1))) to (((7))), wherein the processor is configured to:
receive an operation input from the user even during the synchronization process; and
in a case where it is not possible that a process of a content subjected to the operation input is executed in parallel with the synchronization process, stop the synchronization process that is being executed and execute the process of the content subjected to the operation input.

### 9

The information processing system according to (((8))), wherein the processor is configured to:
execute the stopped synchronization process after the execution of the process of the content subjected to the operation input is ended.

### 10

A program for causing a computer to execute a process comprising:
executing a process affecting work of a user at a timing at which the process does not affect the work of the user, in a synchronization process of synchronizing data stored in an external device with data in an information processing system.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
execute a process affecting work of a user at a timing at which the process does not affect the work of the user, in a synchronization process of synchronizing data stored in an external device with data in the information processing system.

2. The information processing system according to claim 1, wherein the processor is configured to:
execute the synchronization process in a time range set in advance.

3. The information processing system according to claim 2, wherein the processor is configured to:
set the time range based on an instruction of the user.

4. The information processing system according to claim 2, wherein the processor is configured to:
execute the synchronization process that is exceptionally instructed to be executed, regardless of the time range set in advance.

5. The information processing system according to claim 2, wherein the processor is configured to:
execute the synchronization process that is instructed to be immediately executed, regardless of the time range set in advance.

6. The information processing system according to claim 1, wherein the processor is configured to:
in a case where the synchronization process of setting information that is information related to setting necessary for an operation of the information processing system is included in the synchronization process,
continuously execute the synchronization process of the setting information and a restart process associated with the synchronization process of the setting information; and
set a period in which the synchronization process of the setting information and the restart process associated with the synchronization process of the setting information are executed, as a prohibition period in which an operation input from the user is prohibited.

7. The information processing system according to claim 6, wherein the processor is configured to:
receive an operation input having contents other than contents related to an instruction to execute the process even in the prohibition period.

8. The information processing system according to claim 1, wherein the processor is configured to:
receive an operation input from the user even during the synchronization process; and
in a case where it is not possible that a process of a content subjected to the operation input is executed in parallel with the synchronization process, stop the synchronization process that is being executed and execute the process of the content subjected to the operation input.

9. The information processing system according to claim 8, wherein the processor is configured to:
execute the stopped synchronization process after the execution of the process of the content subjected to the operation input is ended.

10. A non-transitory computer readable medium storing a program for causing a computer to execute a process comprising:
executing a process affecting work of a user at a timing at which the process does not affect the work of the user, in a synchronization process of synchronizing data stored in an external device with data in an information processing system.

11. An information processing method comprising:
executing a process affecting work of a user at a timing at which the process does not affect the work of the user, in a synchronization process of synchronizing data stored in an external device with data in an information processing system.
